(19) United States
(12) Patent Application Publication
(10) Pub. No.: US 2025/0256359 A1
(43) Pub. Date: Aug. 14, 2025

(54) METHOD FOR LASER PROCESSING OF A METALLIC MATERIAL, BASED ON AUTOMATIC DETERMINATION OF THE MATERIAL OR PROCESSING PARAMETERS

(71) Applicant: ADIGE S.P.A., Levico Terme (Trento) (IT)

(72) Inventors: Mattia VANIN, Mezzocorona (Trento) (IT); Ali Gokhan DEMIR, Milano (IT); Daniele COLOMBO, Renate (Monza Brianza) (IT); Barbara PREVITALI, Milano (IT); Bianca Maria COLOSIMO, Milano (IT); Lucia FERRARIO, Uboldo (Varese) (IT); Marco Luigi Giuseppe GRASSO, Milano (IT)

(21) Appl. No.: 18/857,218

(22) PCT Filed: Dec. 19, 2023
(86) PCT No.: PCT/IB2023/062907

§ 371 Date: Oct. 16, 2024

(30) Foreign Application Priority Data
Dec. 20, 2022 (IT) 102022000026064

(51) Int. Cl. B23K 26/60; B23K 26/03; B23K 26/0622; B23K 26/382; B23K 26/40; B23K 31/12

(52) U.S. Cl. CPC B23K 26/60; B23K 26/032; B23K 26/0622; B23K 26/382; B23K 26/40; B23K 31/12

(57) ABSTRACT

A machine and a method for laser processing of a metallic material are provided. The method involves controlling an emission of at least one pulse of a characterization laser beam on a predetermined region of the metallic material in a characterization atmosphere to generate a metal vapor and/or plasma from the metallic material, acquiring spectral data representative of an optical emission spectrum of the metal vapor or plasma indicative of the metallic material being processed, identifying one of a plurality of predetermined classes of material or predetermined classes of processing parameters corresponding to the spectral data acquired by electronic processing and automatic recognition devices configured in a supervised learning phase through a set of training spectral data samples indicative of predetermined classes of material or predetermined classes of material processing parameters, and selecting current processing parameters of the metallic material depending on the identified class of material or class of processing parameters.

The present invention relates to laser processing of a material, more specifically a metallic material, and in particular improvements in a method and in a machine for laser processing of a material, more specifically for laser cutting, drilling or welding of said material or the additive manufacturing of three-dimensional structures from powders of said material.

More specifically, the invention relates to a method for laser processing of a metallic material as specified in the preamble of claim 1.

According to a further aspect, this invention relates to a machine for laser processing of a metallic material, according to the preamble of claim 18.

In the following description and claims, the term “metallic material” is used to identify any manufactured article, such as a sheet or an elongated profile having, without distinction, a closed cross-section—for example with a hollow circular, rectangular or square shape—or an open cross-section—for example a flat section or an L-, C-, U-, H-, I-shaped section, etc.

In the industrial processing of materials, and of metal sheets and profiles in particular, the laser is used as a thermal tool for a large variety of applications that depend on the interaction parameters of the laser beam with the material being processed, specifically on the energy density by volume of incidence of the laser beam on the material and on the interaction time interval.

Laser processing machines are well known and comprise industrial processing machines with a CO₂ or ytterbium-doped fiber laser source, or even with a direct diode laser source, which is adapted to emit a single-mode or multi-mode laser beam, with an optical path of the laser beam in air or optical fiber. From the source of emission, the laser beam is conducted along an optical transport path of the beam to a processing head, which comprises an optical system for focusing the laser beam along an optical propagation axis incident on the material.

By directing a laser beam with low energy density (on the order of tens of W per mm² of surface) for a prolonged time (on the order of seconds) on a metallic material, a hardening process is carried out, whereas by directing a laser beam with high energy density (on the order of tens of MW per mm² of surface) for a time on the order of femtoseconds or picoseconds on the same metallic material, an ablation process is carried out. In the intermediate range of increasing energy density and decreasing processing time, the control of these parameters allows welding, cutting, perforation, etching, and marking processes to be carried out.

The difference between the various types of processing that may be carried out on a material is therefore substantially attributable to the power of the laser beam used and to the interaction time between the laser beam and the material being processed.

Also in additive manufacturing, control of the laser beam power and the interaction time between the laser beam and the material is crucial to achieving the processing goals, ensuring the desired properties of shape, compactness and stability of the resulting structure.

It is therefore clear that, within the framework of a predetermined type of processing, the quality of the processing depends on the setting of the interaction parameters of the laser beam with the material being processed, which in turn depend on the type of material being processed and the conditions (e.g., the surface and environmental conditions) in which it is at the time of processing.

In fact, different metal alloys respond differently to the processing laser beam, and further differences in the execution of the process are encountered as a result of the surface conditions of the material, such as its state of oxidation or other surface modifications such as the presence of metallic surface coating layers or layers of protective oils, and of the process atmosphere.

Often, however, it is not possible to know precisely the actual composition of a metal alloy, as it may vary over time and as a result of the storage conditions with respect to that which is indicated by the manufacturer. Further, the processing of a material may use different types of assist gases with parameters that depend differently on the state of said material.

Therefore, the desire is felt to improve the quality of industrial processes of laser processing by adapting the machining parameters as efficiently and quickly as possible to the material being processed and to the actual processing conditions.

The object of the present invention is to provide a method for laser processing of a metallic material that is optimized for the material and the processing conditions.

A further object of the present invention is to provide an optimized method of laser processing of a metallic material that may be implemented efficiently and in a production line.

According to the present invention, these objects are achieved by a laser processing method of a metallic material having the features claimed in claim 1.

Particular embodiments form the subject matter of the dependent claims, the content of which is to be understood as an integral part of the present description.

A further subject matter of the invention is a machine for laser processing of a metallic material as claimed.

In summary, the present invention draws its inspiration from the consideration that the type of a material undergoing processing, typically a metal alloy, may be deduced—in qualitative terms—from optical emission phenomena of a metal vapor or a plasma (or combination thereof) emitted from the material to be subjected, or already subjected, to processing and detected through the acquisition of an optical emission spectrum in a spatial region surrounding the material and in proximity thereto. The term “material to be subjected, or already subjected, to processing” refers to the material exposed to the processing laser beam, and thus to a surface layer of the material (of finishing, coating or due to unwanted oxidation) or a sub-surface layer that is exposed in the course of processing. The term “optical emission” refers to a detectable emission over a broad electromagnetic spectrum, also comprising regions in the ultraviolet and infrared, caused by the ionization of the metal vapor or plasma or—in the case of infrared—indicative of thermal emission. The spectra collected are used for the identification of the material to be processed, not for the monitoring or 2-dimensional or 3-dimensional mapping of the process.

In particular, the invention draws its inspiration from the technique of spectroscopic characterization of materials known as LIBS, Laser-Induced Breakdown Spectroscopy, which allows for the identification of the chemical composition of a sample at the atomic level either qualitatively or quantitatively (relative ratio of different elements within the sample) through the analysis of the optical spectrum obtained by creating a plasma from the material using a laser.

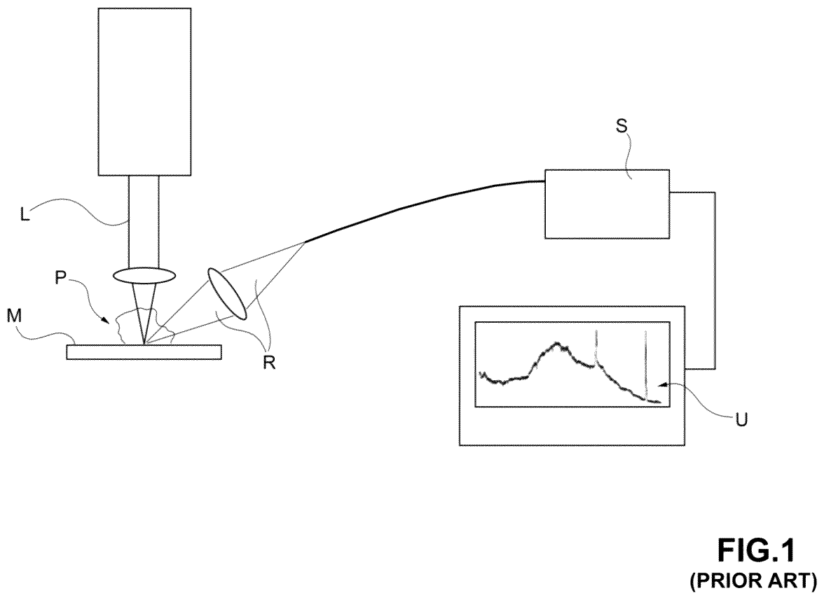

The operation of the technique is schematized in FIG. 1. A short laser pulse L is focused on a sample (material) M, and, through the radiation-matter interaction, a plasma plume P is formed. During the recombination of ions and electrons, there is an emission of radiation R, in the optical band from ultraviolet to near-infrared: a part thereof is a continuous emission, the other part is characteristic of the chemical elements that make up the sample. The radiation is then collected through an optical line and conducted to a spectrometer S where it is divided into the various wavelengths. This results in a spectrum U of emission characteristic of the material, but also influenced by the laser used and the atmosphere in which the process takes place. The collected spectra are then analyzed and processed with appropriate algorithms that also allow the chemical composition of the material to be traced quantitatively.

The lasers used for characterizations of materials through the LIBS technique are typically Q-switched pulsed lasers of high irradiance, 10¹⁰-10¹⁵ W/cm², with pulse durations on the order of nanoseconds. Although lasers with pulses on the order of femtoseconds may be used in the laboratory in a vacuum, the most common portable systems are based on Nd:YAG lasers with emission at the wavelength of 1064 nm in air and which only in some cases have the ability to act in an inert atmosphere (such as Argon).

The analysis and processing of the collected spectra is done by comparison with preexisting datasets or standard samples for the fine calibration of the instrument, whereby a quantitative assessment of the chemical composition of the material may be obtained.

In an innovative way, the method of the invention uses the LIBS technique to control the laser processing of a material. Specifically, the control of the laser processing of a material is done by selecting the processing parameters of the material depending on the material class or on the class of processing parameters associated with the characteristic spectral data of the optical emission of the metal vapor or plasma (or a combination thereof) generated by the material, i.e., identified by automatic recognition from such spectral data, wherein the automatic recognition is based on supervised learning of the correspondence between a set of training spectral data samples and related classes of materials or classes of processing parameters.

The method covered by the invention is implementable by a system adaptable to a laser processing machine, which may be easily integrated thereon, even sharing part of the physical hardware (i.e., the laser source and part of the optical path intended to perform the processing) or processing resources already present on the machine and provided for controlling the laser beam and the laser processing as a whole. Advantageously, in fact, the method covered by the invention is implementable by using the laser beam generated by the laser source as a processing tool in innovative ways to generate the emission of metal vapor or plasma from the material, which is necessary for the characterization thereof.

Advantageously, the quality of a laser process is improved as a result of the identification in line (i.e., not in a vacuum, but possibly in a protected atmosphere) of the optimal processing parameters that best approximate (or coincide with) the machining parameters adopted in previous processes applied to a material having the same (or closest) spectroscopic signature, i.e., the same (or closest) type of material to be processed. In-line identification of the processing parameters, either directly or through material identification, is advantageously implemented immediately prior to processing, so as to enable automatic and more precise calibration of the parameters required for processing, remedying any errors in the prior indication of the material and adapting the calibration to the bulk material or to the specific surface treatment.

In a further advantageous way, the technique covered by the invention makes it possible to detect on board a machine a metallic material being processed during laser processing of the material and continuously during the process, without the need for downtime or a prior acquisition, in particular a visual acquisition by an operator, of the data of the material received from the supplier.

Ultimately, the invention makes it possible to improve a process of laser processing of metallic materials as a result of the material recognition directly in the machine, as it makes it possible to identify any errors in the prior indication of the material being processed, avoiding production waste, containing the production costs and optimizing the expected quality of the finished product.

Further features and advantages of the invention will be presented in greater detail in the following detailed description of an embodiment thereof, given by way of non-limiting example, with reference to the accompanying drawings, wherein:

FIG. 1, described above, shows the operational diagram of the LIBS technique;

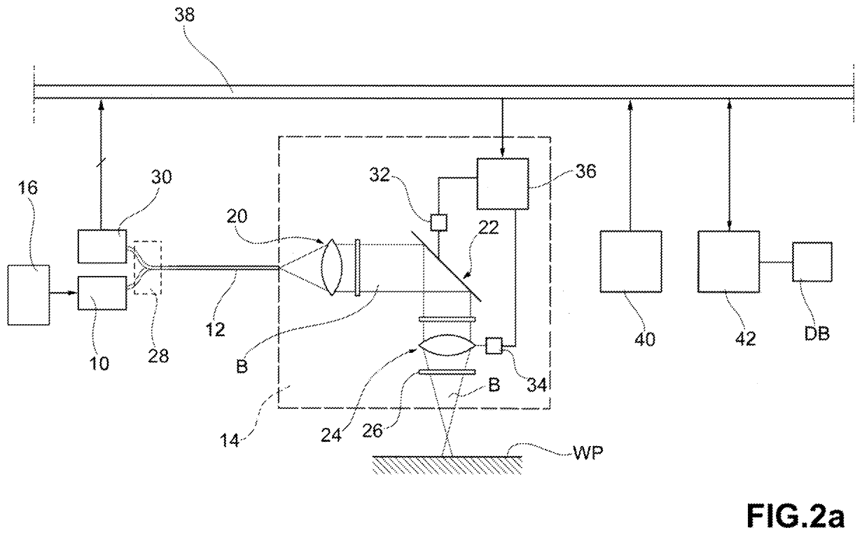

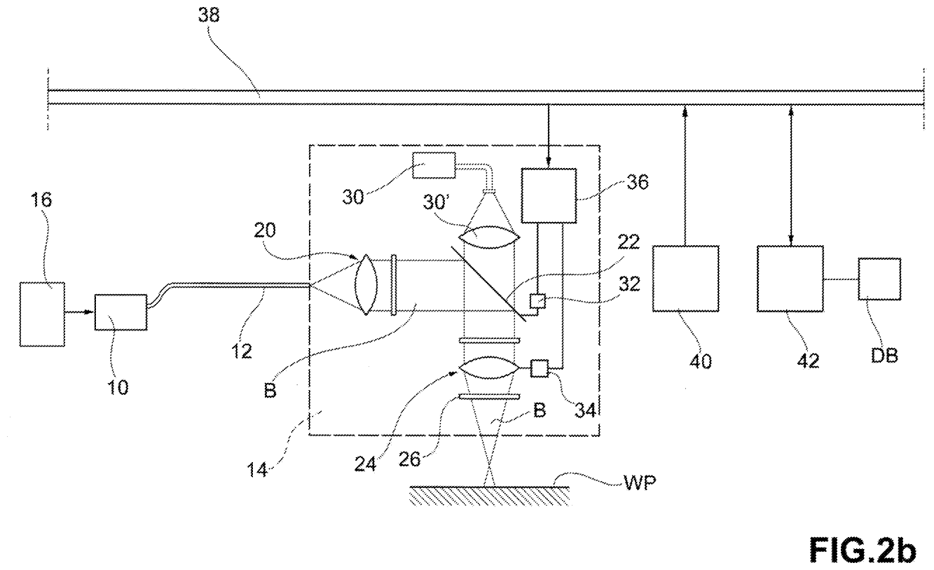

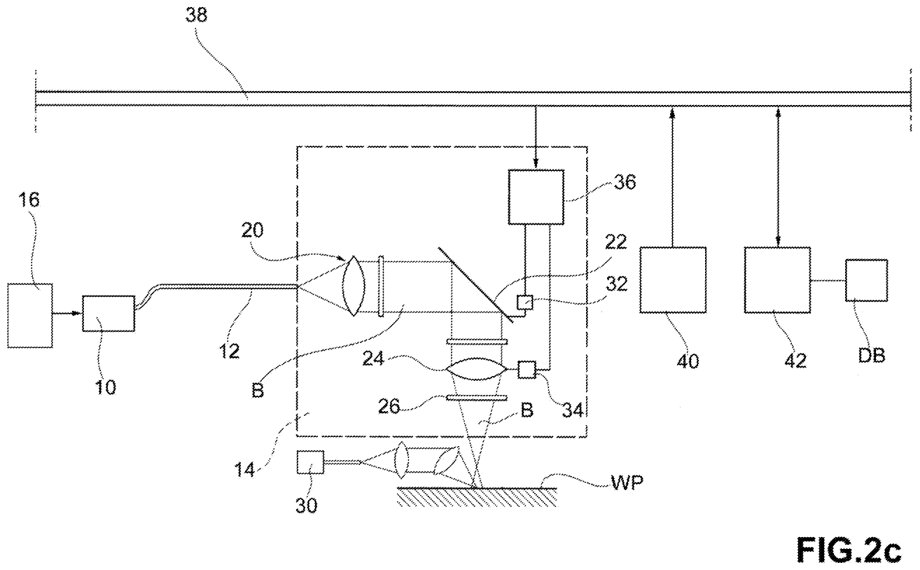

FIG. 2a-2c schematically show three different configurations of a machine for laser processing of a metallic material operating according to the method covered by the invention, wherein identical or functionally equivalent elements or components are shown with the same references;

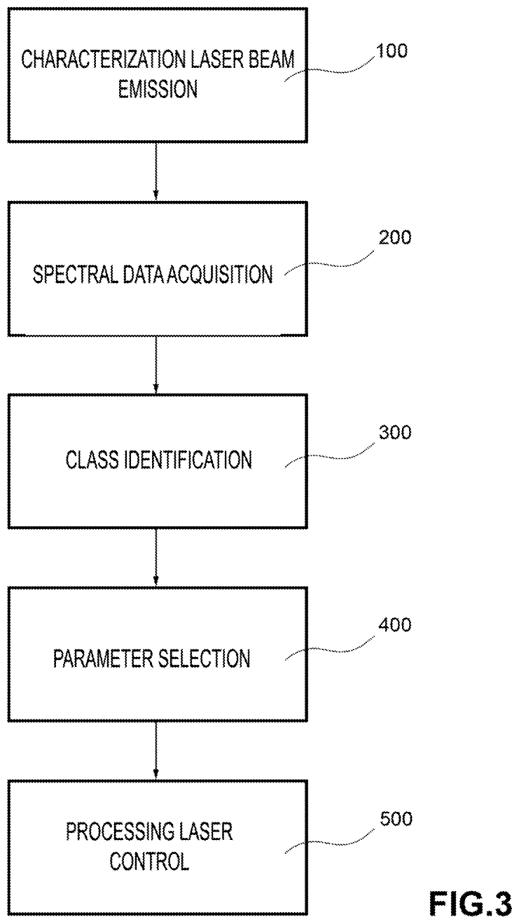

FIG. 3 is a flowchart of the operations conducted for the preparation of a laser processing of a metallic material, according to the method covered by the invention;

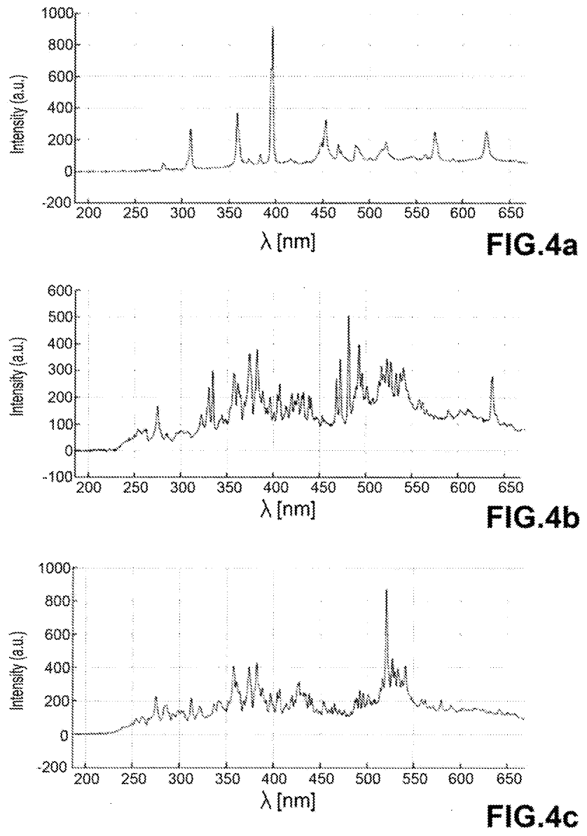

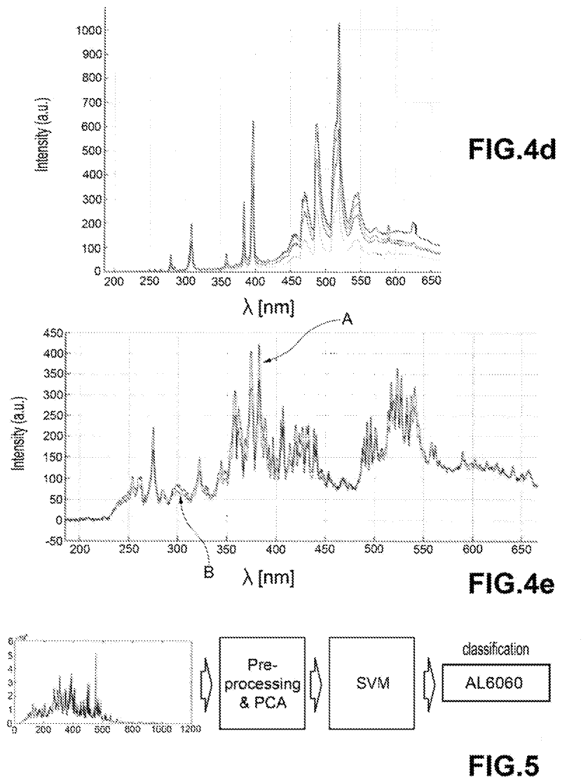

FIG. 4a-4e are optical plasma emission spectra of exemplary materials;

FIG. 5 is a schematic representation of the preferred classification method adopted in the method covered by the invention;

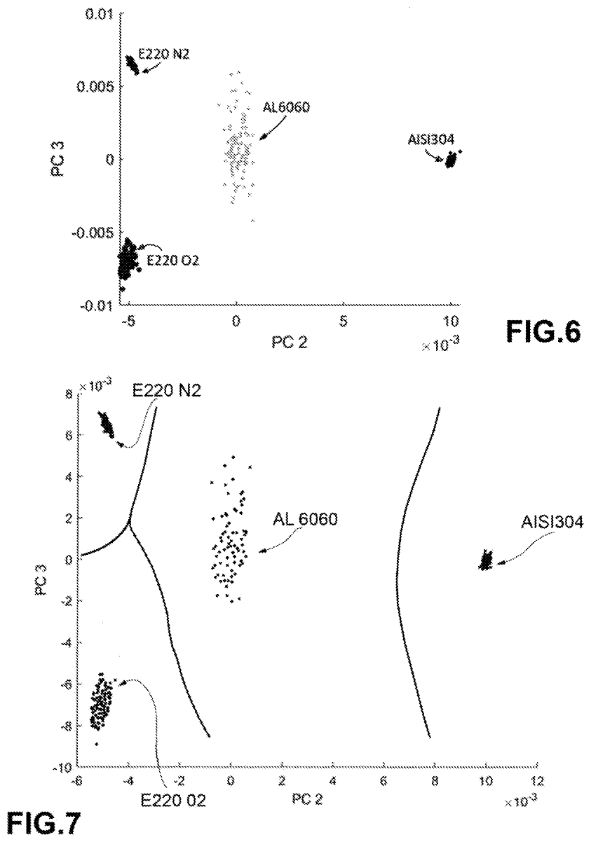

FIG. 6 is a projection plot of spectral data in a two-dimensional classification space defined by two principal components, representative of four classes of materials;

FIG. 7 shows a breakdown of the classification space in FIG. 5 that maximizes the margin between the classes; and

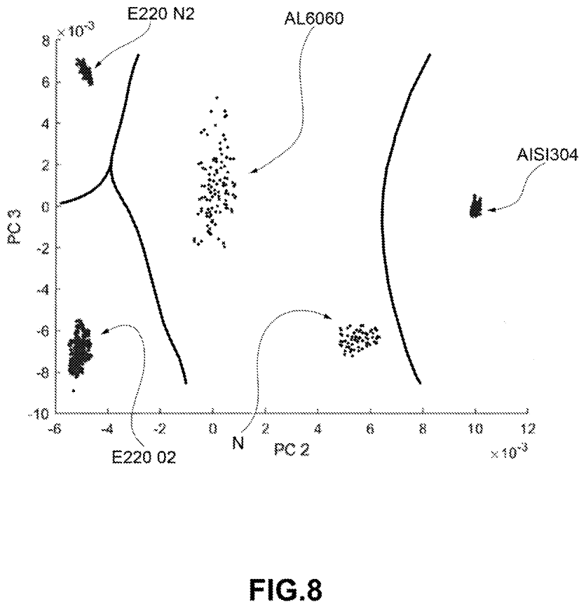

FIG. 8 shows a new class of spectral data within the breakdown of FIG. 6 in a condition of characterization anomaly.

FIG. 1 has been described above and its contents are intended to be referred to here as common to the construction of a controlled processing machine for implementing a method according to the teachings of the present invention.

FIG. 2a is a schematic representation of a machine for laser processing of a metallic material according to the invention, in a first configuration.

The machine of FIG. 2a includes at least one laser emission source 10, adapted to emit a laser beam B in a transport means, for example an optical fiber 12, adapted to conduct the processing laser beam emitted from the source towards a processing head 14 located in the proximity of a material WP. The processing laser beam B is, for example, a continuously emitted laser beam with a peak power of 1 kW or more.

A laser emission control unit 16 arranged to control the power and emission duration parameters of the laser beam B and/or to select one among a plurality of laser beams, in the case of multiple sources, may be coupled to the source 10. In one embodiment, the control unit 16 is thus arranged to control the emission of at least one pulse of a characterization laser beam on a predetermined region of the material WP, which is adapted to generate a metal vapor and/or a plasma, and a subsequent optical and thermal emission represent the “signature” of the material. As a result of the power and/or pulse duration of the characterization laser beam, the material undergoes a process of progressive heating, which results in part in its vaporization and subsequently the possible excitation and ionization to form a plasma. In the volume of space surrounding the point of incidence of the characterization laser beam on the material, an atmosphere is formed that may present in combination metal vapor and plasma—also known as “plume”—or only one thereof. The characterization laser beam may be generated from a source (not shown) separate from the source 10 and conducted separately to the processing head, where said characterization laser beam is advantageously guided along an optical path common to the processing laser beam.

In a currently preferred embodiment, a single source 10 is used, and the characterization laser beam is obtained by modulation of the continuously emitted processing laser beam, such as by emitting one or more laser pulses for a duration of between 10 and 200 microseconds through modulation of the processing laser beam. In this way, the additional cost of a second source in the machine is eliminated.

The processing head 14 includes an optical system typically comprising a set of optical elements such as a collimating lens 20, a beam shaping mirror 22, a focusing lens 24 and a protective optical element 26.

An optical combiner device 28 is associated with the source and arranged to combine and launch a plurality of laser beams on the transport fiber, as well as to direct an optical signal—emitted from the metal vapor or plasma of the material and collected by the optical system of the processing head—to spectral data acquisition means 30 such as a spectrometer, adapted to acquire spectral data representative of an optical emission spectrum of the metal vapor or plasma generated by the characterization laser beam. These spectral data are indicative of the material WP subjected to processing. Although not shown in the figure, the path for the optical signal downstream of the combiner device 28 toward the spectrometer 30 may comprise an optical collimating and filtering system.

Associated with the processing head 14 are optical system actuator means identified in the figure by way of example as actuator means 32 of the movement of the beam shaping mirror 22 and actuator means 34 of the beam focus adjustment acting on the focusing lens 24, both of which are controlled by a control unit denoted overall by 36, connected to a fieldbus 38, to which processing and controlling means 40 are also connected, arranged to control the application of the processing laser beam along a predetermined processing trajectory. Controlling the application of the processing laser beam along the predetermined processing path includes controlling the delivery of an assist gas flow (in cutting applications) and controlling the irradiation of a predetermined power distribution of the laser beam towards a predetermined working area by reference to a predetermined working model or program, i.e. according to the working trajectory information and working parameters acquired in the form of movement instructions for the processing head and/or of the material being processed, and physical processing parameters indicative of the power distribution of the optical beam, beam power intensity and activation times of the laser beam as a function of the processing trajectory. The processing means 40 may be integrated in a single processing unit on board the machine or implemented in distributed form, whereby they comprise processing modules located in different parts of the machine, including, for example, the processing head.

The main advantages of this configuration are a non-intrusive installation of spectral data acquisition means, with no modification or dedicated design of the processing head being necessary to accommodate a spectrometer, and an overall more robust system since there is no delicate instrumentation near the processing area. These considerations make the configuration preferable in an industrial context. Emissions at wavelengths shorter than 400 nm may not generally be observed in this configuration because the optical fiber 12 as a transport means does not transmit light in the ultraviolet region. Further, emission peaks will be present at the emission wavelength of the characterization and processing laser beam.

In an alternative embodiment to that described including the optical combiner device 28, which is shown in FIG. 2b in which elements or components identical or functionally equivalent to those illustrated in FIG. 2a are shown with the same references, the spectral data acquisition means 30 are separate from the laser source and integrated into the processing head 14.

In this configuration, the optical signal emitted from the metal vapor or the plasma of the material is collected by the optical system of the processing head, including the protective optical element 26 and the focusing lens 24, and is transmitted through a dichroic beam-shaping mirror 22 toward the spectral data acquisition means 30 integrated in the processing head 14. The path for the optical signal downstream of the dichroic mirror 22 to the spectrometer 30 may comprise a collimating and filtering optical system 30′.

In each case, the collection line, which allows the acquisition of the optical signal emitted from the metal vapor or plasma, includes a spectrometer that uses either a very broad band (ultraviolet to near-infrared) or only a part thereof. Alternatively, sensor means aimed at determining the intensity of the signal only at predetermined wavelengths in the near-infrared to the ultraviolet optical band, such as multiple photodiodes, might be used.

Advantageously, in the two configurations described, the collection of the optical signal to the spectral data acquisition means 20 takes place according to a coaxial configuration, in which the optical signal follows at least for a certain distance the same optical propagation path as the characterization and processing laser beam, through the processing head, even more advantageously up to the optical combiner device 18 associated with the source. Using the same optical system to focus the characterization (and processing) laser beam and to acquire the optical emission of the plasma ensures that the emission is collected from the same region of the material wherein the plasma is generated.

Alternatively, as shown in FIG. 2c wherein elements or components identical or functionally equivalent to those illustrated in FIG. 2a are shown with the same references, the collection of the optical signal may take place off-axis externally to the processing head through the lateral positioning of the spectral data acquisition means 30 at a distance and an angle with respect to the defined propagation direction of the characterization and processing laser beam, depending on the space available in the machine. This configuration allows the collection of spectral data that is neither distorted nor filtered by the optical shaping system of the characterization and processing laser whereby the natural shape of the emissions is maintained, as well as the possibility of acquiring spectral data also in the ultraviolet region. In any case, it is preferable to place a cutoff filter of the reflection wavelengths of the laser beam on the material so as not to saturate the emission spectrum. Disadvantageously, because the optical emission of the metal vapor or plasma from the material is not collected through the optical focusing system of the characterization (and processing) laser beam, any change in the position of the processing head with respect to the material (e.g., a change in the processing distance from the material) requires an adjustment of the distance and positioning angle of the acquisition means of the spectral data with respect to the propagation direction of the characterization and processing laser beam.

In each of the described configurations, electronic processing and automatic recognition means 42, coupled with a data logging memory DB, arranged to process signals emitted from the spectral data acquisition means 30 and to identify one of a plurality of predetermined classes of material or predetermined classes of processing parameters corresponding to said spectral data, are connected to the fieldbus 38. The electronic processing and automatic recognition means 42 are configured in a supervised learning phase using a set of training spectral data samples indicative of predetermined classes of materials or predetermined classes of material processing parameters. The set of training spectral data samples may be obtained based on nameplate data of materials that are the subject of previous processing and updated periodically, or through a preliminary acquisition of spectral data samples, such as several tens of spectra for each of the available materials. The electronic processing and automatic recognition means 42 are configured to select the processing parameters corresponding to the processing parameter class or material class identified by the data logging memory DB, which includes a reference model indicative of a nominal relationship between spectral data and processing parameter classes or material classes.

In general, the term “processing parameters” refers to physical parameters of the processing laser beam and the processing environment, e.g., to at least one among the repetition rate of the processing laser beam pulses, the duration of the processing laser beam pulses, the power of the processing laser beam pulses, the power density distribution of the processing laser beam, the pressure of an assist gas, or—more generally—to processing strategies that include one or more of the physical parameters of the processing laser beam and the processing environment, as well as control parameters of the movement of the processing beam.

The processing and controlling means 40 are arranged for controlling the application of the processing laser beam along the predetermined processing trajectory according to the selected processing parameters.

A flowchart of the method covered by the invention is briefly shown in FIG. 3.

At step 100, the control unit 16, triggered by the processing and controlling means 40 or by the electronic processing and automatic recognition means 42, controls the emission of at least one pulse of a characterization laser beam on a predetermined region of the material WP in a characterization atmosphere, so as to generate a metal vapor and/or plasma from the material. In a particular case, the characterization atmosphere is the same as the atmosphere of the working process.

The control unit 16 controls the emission of at least one pulse of the characterization laser beam in an early stage of processing the material, such as on a region of the material intended to be subjected to cutting or drilling, or in a calibration step prior to the processing of the material, on an area of the material not subjected to processing.

The control unit 16 may also control the emission of at least one pulse of the characterization laser beam during the processing of the material, advantageously in the case wherein the characterization laser beam is obtained by modulation of the processing laser beam, possibly by modifying the process atmosphere to provide, temporarily, a different characterization atmosphere.

At step 200, the spectral data acquisition means 30 acquire the spectral data representative of an optical emission spectrum of the metal vapor or plasma, indicative of the material WP being processed.

By way of example, the spectra of the aluminum alloy Al 6060 (FIG. 4a), galvanized steel (FIG. 4b) and stainless steel AISI 304 (FIG. 4c) are shown in FIG. 4a-4c. Different intensity values of the optical emission may be detected as a function of the generation conditions of the plasma by the material, such as due to the power of the characterization laser beam or to the process atmosphere and more generally to the laser processing machine used, as shown in FIG. 4d, where spectra of the aluminum alloy Al 6060 in an oxygen atmosphere obtained from characterization laser beams emitted from different laser processing machines with different powers and diameters are shown. Different spectra are also obtained as a function of the surface condition of the material, such as its state of oxidation or its coating, as shown in FIG. 4e where a comparison between the spectra of the carbon steel S235JR under normal conditions (curve A) and the rusted carbon steel S235JR (curve B) is shown.

At step 300 the electronic processing and automatic recognition means 42, configured beforehand in a supervised learning step not shown in the figure, identify one of a plurality of predetermined classes of material or predetermined classes of processing parameters corresponding to the acquired spectral data.

Before applying an automatic recognition algorithm to the spectral data, it is useful to normalize said data in order to have comparable data since even in the presence of the same parameters of the characterization laser beam there may be some degree of variability in the overall intensity of the optical emissions of the plasma. Due to the spectral normalization, it is possible to compensate for any fluctuations in the intensities of the acquired spectral data.

Each spectrum includes a plurality of N emission lines I(λᵢ) (i=1, . . . , N) acquired in a predetermined wavelength range between ultraviolet and infrared (e.g., between 181 nm and 1100 nm with an average resolution of 0.56 nm).

Two normalization procedures may be employed advantageously. The first is to normalize the spectra by dividing all emission line intensities by the maximum intensity (in other words, representing the maximum peak with the value 1 and scaling the other values accordingly), according to the expression:

$${I}_{n o r m} ( {λ}_{i} ) = \frac{I ( {λ}_{i} )}{max I ( {λ}_{i} )}$$

The second procedure is to divide each intensity of the emission lines by the sum of all the intensities (essentially scaling the respective values relative to the total emission represented by the area subtended by the spectral curve), according to the expression:

$${I}_{n o r m} ( {λ}_{i} ) = \frac{I ( {λ}_{i} )}{{\sum }_{i = 1}^{N} I ( {λ}_{i} )}$$

Iₙₒᵣₘ retains the information about the shape of the spectrum that represents the signature of the material and thus useful information that enables the automatic recognition algorithm to perform the classification.

At step 400 the electronic processing and automatic recognition means 42 select the current processing parameters of the material depending on the material class or the recognized processing parameter class.

Finally, in step 500, the processing and controlling means 40 control the irradiation of the processing laser beam in a predetermined area or along a predetermined processing trajectory of the metallic material according to the current processing parameters selected in the previous step.

Expediently, in order to be able to recognize a material over a large surface area, or in a depth volume, wherein material conditions might vary, step 100 is repeated, in succession, or at predetermined processing intervals, whereby the control unit 16 controls the emission of a plurality of pulses of the characterization laser beam on a succession of predetermined regions of a two-dimensional surface scanning area of the material, or on a succession of predetermined regions of a three-dimensional scanning volume of the material, so as to generate a respective metal vapor or plasma from the material present in such scanning regions. For example, The control unit 16 may control the emission of a plurality of pulses of the characterization laser beam over a succession in depth of predetermined regions of a three-dimensional scanning volume of the material, focusing the characterization laser beam on different planes of the material, so as to include a surface layer of the material and at least one subsurface layer, exposed as a result of the characterization of the overlying layer.

More specifically, the electronic processing and automatic recognition means 44 may be advantageously implemented as recognition and classification modules based on principal component analysis (PCA) techniques for the extraction of characteristics and on artificial intelligence classification systems, e.g., neural networks or support vector machines (SVMs). The spectral data may be processed through statistical techniques of various kinds, not only PCA but also through normalization techniques, such as by using spectral data acquired over the entire detection spectrum.

A schematic representation of the aforementioned classification method is shown in FIG. 5.

In the currently preferred embodiment, the identification of the material class or of the class of processing parameters corresponding to the acquired spectral data is done by transforming the acquired spectral data into a classification space defined by predetermined orthogonal latent variables which include a subset of predetermined significant latent variables indicative of the variance of the spectral data, and comparing the value of an n-tuple of said significant latent variables, computed from the detected spectral data, with a set of reference values of said n-tuple of significant latent variables, indicative of a set of training spectral data samples. The parameters corresponding to the predetermined processing parameters associated with the reference values of the n-tuple of latent variables that have a predetermined metric relationship with the value of the n-tuple of significant latent variables calculated from the detected spectral data are selected as the processing parameters of the material.

Advantageously, the predetermined metric relationship is a minimum distance relationship.

FIG. 6 shows a projection of the spectral data acquired in a two-dimensional classification space defined by the principal components identified as PC2 and PC3, for a specific characterization laser beam and a specific characterization atmosphere, where the training spectral data samples include four classes, respectively the materials Al6060 (aluminum, magnesium, silicon family alloy), AISI304 (stainless steel), E220 (steel) characterized in O₂ atmosphere and E220 (steel) characterized in N₂ atmosphere. As may be seen graphically, the space of the two principal components PC2 and PC3 clearly distinguishes between the four classes of training spectral data samples.

FIG. 7 shows the spatial partition of the principal components PC2 and PC3 resulting from the application of the SVM classifier. This partition results from using a linear kernel and from the partition function that maximizes the margin between the classes.

As with any type of classifier, each new measurement is classified into one of the known classes (classes used to train the model), even if it is a new material or a new experimental condition. It is evident in FIG. 7 that there are regions far removed from the clusters observed in training within which any new observation would be forcibly classified into one of the known classes, despite the large discrepancy from the training data. Therefore, a refinement to the method may be introduced by extending the classification to reporting whether a given classification outcome is or is not reliable. This may be done, for example, by automatically determining whether the projection in space of the principal components of the new observation lies within (or near to) the cluster of training data belonging to the allocation class or deviates therefrom by a distance greater than a predetermined threshold, and reporting this characterization anomaly condition to an operator. The example shown in FIG. 8 should be considered in which a new class of observations N is characterized by scores that lie within the region of space wherein the material is classified in the Al6060 family, although the acquired spectral data deviate markedly from the corresponding cluster. The characterization anomaly condition is verified if the distance of each representation of an acquired spectral datum, or the distance of the center of the representations of the spectral data acquired in a plurality of observations, from the center of the training spectral data cluster (or clusters of all known training spectral data classes) is greater than a predetermined threshold. The principle behind the distance calculation from a reference cluster in a multi-dimensional space is based on the same mechanism underlying the SVM method, but in a variant thereof known as one-class SVM or Support Vector Data Description (SVDD), as described by Tax, D. M., Duin, R. P., in “Support vector data description. Machine learning”, 54(1), pp. 45-66, 2004, by Ning, X., Tsung, F., “Improved design of kernel distance-based charts using support vector methods”, IIE transactions, 45(4), pp. 464-476, 2013 and from Grasso M., Colosimo B. M., Semeraro Q., Pacella M., “A Comparison Study of Distribution-Free Multivariate SPC Methods for Multimode Data”, Quality & Reliability Engineering International, 31(1), pp. 75-96, 2015.

The characterization anomaly condition may be followed up by investigating with an operator whether it is a new material or a new combination of material and process atmosphere. If so, such data may be added to the reference model as new training spectral data samples, and the classifier may be retrained once a sufficient number of observations attributable to that class are available. If not, it might still be useful to include the new observation in the set of training samples for that material to account for extra variability that was not observed in the first training phase. This would enable improved classification performance in the future. Also in this case, if the training spectral data sample set is expanded, it is necessary to retrain the classification algorithm and also redefine the value of the distance threshold that defines a characterization anomaly reporting condition.

Naturally, without prejudice to the principle of the invention, the embodiments and the details of execution may vary widely with respect to that which has been described and illustrated purely by way of non-limiting example, without thereby departing from the scope of protection of the invention defined by the appended claims.

What is claimed is:

1. A method for laser processing of a metallic material, comprising irradiating a processing laser beam in a predetermined area or along a predetermined trajectory for processing the metallic material, in a predetermined process atmosphere and according to current processing parameters selected on the basis of said metallic material, wherein the method comprises steps of:
controlling an emission of at least one pulse of a characterization laser beam on a predetermined region of the metallic material in a characterization atmosphere so as to generate a metal vapor and/or plasma from the metallic material;
acquiring spectral data representative of an optical emission spectrum of the metal vapor or plasma indicative of the metallic material being processed in said characterization atmosphere;
identifying one of a plurality of predetermined classes of material or predetermined classes of processing parameters corresponding to said spectral data by electronic processing and automatic recognition means configured in a supervised learning phase using a set of training spectral data samples indicative of predetermined material classes or predetermined classes of material processing parameters; and
selecting the current processing parameters of the metallic material depending on the identified class of material or class of processing parameters.

2. The method of claim 1, wherein said predetermined processing parameters comprise at least one of repetition frequency of pulses of the processing laser beam, duration of the pulses of the processing laser beam, power of the pulses of the processing laser beam, distribution of power density of the processing laser beam, assist gas pressure.

3. The method of claim 1, comprising controlling the emission of the at least one pulse of the characterization laser beam at an early stage of the laser processing of the metallic material, on a region of the metallic material to be cut or drilled.

4. The method of claim 1, comprising controlling the emission of the at least one pulse of the characterization laser beam in a calibration step prior to the laser processing the metallic material, on an area of the metallic material not subject to the laser processing.

5. The method of claim 3, comprising controlling an emission of a plurality of pulses of the characterization laser beam on a succession of predetermined regions of a two-dimensional scanning area of the metallic material or on a succession of predetermined regions of a three-dimensional scanning volume of the metallic material in such a way as to generate a respective metal vapor or plasma from the metallic material present in said predetermined regions.

6. The method of claim 5, wherein controlling the emission of the plurality of pulses of the characterization laser beam on the succession of predetermined regions of the three-dimensional scanning volume of the metallic material comprises focusing said laser beam on different planes of the metallic material, including a surface layer of the metallic material and at least one subsurface layer, a first pulse generating a metal vapor or plasma from the material of the surface layer and at least a second pulse generating a metal vapor or plasma from the material of the at least one subsurface layer.

7. The method of claim 1, wherein the spectral data representative of the optical emission spectrum of the metal vapor or plasma of the metallic material are acquired in an optical band between near-infrared and ultraviolet.

8. The method of claim 7, wherein the spectral data representative of the optical emission spectrum of the metal vapor or plasma of the metallic material are acquired at predetermined wavelengths in the optical band between near infrared and ultraviolet.

9. The method of claim 1, wherein said characterization atmosphere is the process atmosphere.

10. The method of claim 1, wherein said characterization laser beam is obtained by modulation of the processing laser beam.

11. The method of claim 10, wherein said at least one pulse of the characterization laser beam is emitted for a duration between 10 microseconds and 200 microseconds by modulation of a continuously emitted processing laser beam with a peak power of 1 kW or more.

12. The method of claim 1, wherein said characterization laser beam is guided along an optical path common to the processing laser beam in a processing head of a machine for implementing the laser processing.

13. The method of claim 10, comprising detecting the optical emission spectrum of the metal vapor or plasma coaxial to a propagation direction of the processing laser beam in a processing head of a machine for implementing the laser processing.

14. The method of claim 10, comprising detecting the optical emission spectrum of the metal vapor or plasma at a predetermined angle to a propagation direction of the processing laser beam in a processing head of a machine for implementing the laser processing, outside the processing head.

15. The method of claim 1, comprising controlling the emission of the at least one pulse of the characterization laser beam during the laser processing of the metallic material.

16. The method of claim 1, wherein identifying one of the plurality of predetermined classes of material or classes of processing parameters corresponding to said spectral data by the electronic processing and automatic recognition means includes:
transforming said spectral data into a classification space defined by predetermined orthogonal latent variables, said predetermined orthogonal latent variables including a subset of predetermined significant latent variables indicative of a variance of said spectral data; and
comparing a value of an n-tuple of said significant latent variables calculated from said spectral data with a set of reference values of said n-tuple of significant latent variables indicative of said set of training spectral data samples, and wherein
the material processing parameters are selected corresponding to the predetermined processing parameters associated with the reference values of said n-tuple of significant latent variables that have a predetermined metric relationship with the value of said n-tuple of significant latent variables calculated from the acquired spectral data.

17. The method of claim 16, wherein said predetermined metric relationship is a minimum distance relationship.

18. A machine for laser processing of a metallic material, comprising:
a source for emitting a processing laser beam;
means for conducting the processing laser beam emitted from said source along an optical path for transporting the processing laser beam to a processing head located in a vicinity of said metallic material; and
processing and controlling means arranged for controlling an application of said processing laser beam along a predetermined processing trajectory on the metallic material, in a predetermined process atmosphere and according to current processing parameters selected on the basis of said metallic material, wherein the machine further comprises:
a source for emitting at least one pulse of a characterization laser beam on a predetermined region of the metallic material in a characterization atmosphere, so as to generate a metal vapor and/or plasma from the metallic material;
means for acquiring spectral data representative of an optical emission spectrum of the metal vapor or plasma indicative of the metallic material being processed in said characterization atmosphere; and
electronic processing and automatic recognition means configured in a supervised learning phase by a set of training spectral data samples indicative of predetermined classes of materials or predetermined classes of material processing parameters and arranged to identify one of a plurality of predetermined classes of materials or predetermined classes of processing parameters corresponding to said acquired spectral data, and wherein
said processing and controlling means are arranged for controlling the application of said processing laser beam according to selected current processing parameters depending on the identified class of material or class of processing parameters.

19. The method of claim 1, wherein said method is for laser cutting, drilling or welding of a volume of the metallic material or additive manufacture of three-dimensional structures from powders of the metallic material.

20. The machine of claim 18, wherein said machine is for laser cutting, drilling or welding of a volume of the metallic material or additive manufacture of three-dimensional structures from powders of the metallic material.
